(19) United States
(12) Patent Application Publication
(10) Pub. No.: US 2026/0147117 A1
(43) Pub. Date: May 28, 2026

(54) ULTRASOUND DEVICE, IN PARTICULAR FOR APPLICATIONS BASED ON TIME-OF-FLIGHT MEASUREMENT, AND CONTROL METHOD

(71) Applicant: STMicroelectronics International N.V., Geneva (CH)

(72) Inventors: Domenico GIUSTI, Caponago (IT); Marco PASSONI, Cornate d'Adda (MB) (IT); Luigi BARRETTA, Melito di Napoli (IT)

(73) Assignee: STMicroelectronics International N.V., Geneva (CH)

(21) Appl. No.: 19/391,184

(22) Filed: Nov. 17, 2025

(30) Foreign Application Priority Data
Nov. 28, 2024 (IT) 102024000026940

(51) Int. Cl. G01S 15/06

(52) U.S. Cl. CPC G01S 15/06

(57) ABSTRACT

An ultrasound device uses transmission transduction modules of MEMS type, where each transmission transduction module emits a respective ultrasound acoustic wave. Reception transduction modules of MEMS type are configured to each generate an electrical signal in response to the detection of an impinging ultrasound acoustic wave. Control circuitry includes one or more transmission channels configured to drive the emission of ultrasound acoustic waves by the transmission transduction modules. A reception channel of the control circuitry detect the electrical signals generated by the reception transduction modules which are connected in series to input the electrical signal to the reception channel.

### PRIORITY CLAIM

This application claims the priority benefit of Italian Application for Patent No. 102024000026940 filed on Nov. 28, 2024, the content of which is hereby incorporated by reference in its entirety to the maximum extent allowable by law.

### TECHNICAL FIELD

The present invention relates to an ultrasound device and to a respective control method. In particular, the invention relates to an ultrasound device for applications based on time-of-flight measurement such as, for example, eye tracking, gesture recognition, proximity sensors.

### BACKGROUND

As is known, numerous ultrasound devices are available nowadays that are adapted to transmit and receive acoustic waves with frequencies higher than 20 kHz.

In particular, ultrasound devices made by using micro-electro-mechanical systems (MEMS) technology, including Piezoelectric Micromachined Ultrasonic Transducers (PMUTs), are finding wide application by virtue of their small size, low weight, low energy consumption and high sensitivity.

Furthermore, MEMS ultrasound devices are able to work at high frequencies, even in the order of a few MHz, allowing high resolution to be achieved.

In many applications, it may be useful to use a high number of ultrasound transduction modules, this causes that known devices include electronic control circuits of the plurality of transduction modules that are complex and have high manufacturing costs.

For instance, ultrasound devices such as for example PMUTs may be used for eye tracking of a user. The use of acoustic waves allows in fact to operate even in extreme conditions (e.g., in the dark or in the presence of intense light) and such acoustic waves are safe for the user's health.

Furthermore, the high work frequencies of PMUTs allow to accurately detect even small eye movements, for example of a few hundred micrometers.

Eye tracking through ultrasounds is based on the time-of-flight measurement between the emission of an acoustic wave and the reception of the same acoustic wave reflected by the eye.

As shown schematically in FIGS. 1A and 1B, the time of flight (and therefore the distance) measured between a transmission PMUT 1 and a reception PMUT 2 depends on the rotation of the eye 3.

In fact, depending on the position (rotation) of the eye 3 with respect to the PMUTs 1, 2, the time of flight measured with respect to the cornea 4 (FIG. 1A) is lower than the time of flight measured with respect to the sclera 5 (FIG. 1B).

Thus, the position of the eye 3 may be identified based on the variations in the time of flight measured between the PMUTs 1, 2.

The pair of PMUTs 1, 2 may be sufficient to determine whether the eye is looking to the right or to the left.

However, to follow the movement of the eye in more degrees of freedom, for example to also determine whether the eye is looking up or down, then multiple pairs of PMUTs may be necessary, for example even four or five PMUTs.

In known devices, each transmission PMUT comprises a dedicated driving circuit that drives the transmission of the acoustic wave and each reception PMUT comprises a dedicated reception circuit having a respective amplifier that detects the reception of the reflected acoustic wave.

In practice, in known devices, the control circuit is formed by a plurality of transmission channels and a plurality of reception channels, wherein each transmission channel drives a single transmission PMUT module and each reception channel detects the electrical signal generated by a single reception PMUT.

As the number of ultrasound transduction devices increases, the control circuitry becomes increasingly complex, resulting in increased manufacturing costs and energy consumption.

There is a need in the art to overcome, at least in part, the foregoing disadvantages.

### SUMMARY

According to the present invention, an ultrasound device and a control method are thus provided.

In an embodiment, an ultrasound device comprises: a plurality of transmission transduction modules of MEMS type, each configured to emit a respective ultrasound acoustic wave; a plurality of reception transduction modules of MEMS type, each configured to generate an electrical signal in response to the detection of an impinging ultrasound acoustic wave; and control circuitry comprising one or more transmission channels configured to drive the emission of ultrasound acoustic waves by the plurality of transmission transduction modules, and a reception channel configured to detect the electrical signals generated by the plurality of reception transduction modules.

In an embodiment, a method for controlling an ultrasound device, that includes a plurality of transmission transduction modules of MEMS type and a plurality of reception transduction modules of MEMS type, comprises: driving, by one or more transmission channels, the emission of ultrasound acoustic waves by the plurality of transmission transduction modules; and detecting, by a reception channel, electrical signals generated by the plurality of reception transduction modules in response to the detection of impinging ultrasound acoustic waves.

### BRIEF DESCRIPTION OF THE DRAWINGS

For a better understanding of the present invention, embodiments thereof are now described, purely by way of non-limiting example, with reference to the attached drawings, wherein:

FIGS. 1A and 1B schematically show two PMUT devices used for tracking the movement of an eye, in two different positions of the eye;

FIG. 2 shows a block diagram of an ultrasound device;

FIG. 3 shows a block diagram of a transduction module of the device of FIG. 2,;

FIG. 4 shows an ultrasound device for eye tracking in a first condition of use;

FIG. 5 shows an example of signals received by the device of FIG. 4 in the first condition of use;

FIG. 6 shows the device for eye-tracking of FIG. 4 in a second condition of use;

FIG. 7 shows an example of signals received by the device of FIG. 4 in the second condition of use;

FIG. 8 shows the device for eye-tracking of FIG. 4 in a third condition of use;

FIG. 9 shows an example of signals received by the device of FIG. 4 in the third condition of use;

FIG. 10 shows a block diagram of an ultrasound device;

FIG. 11 shows an ultrasound device; and

FIG. 12 shows a circuit diagram of a reception circuit of an ultrasound device.

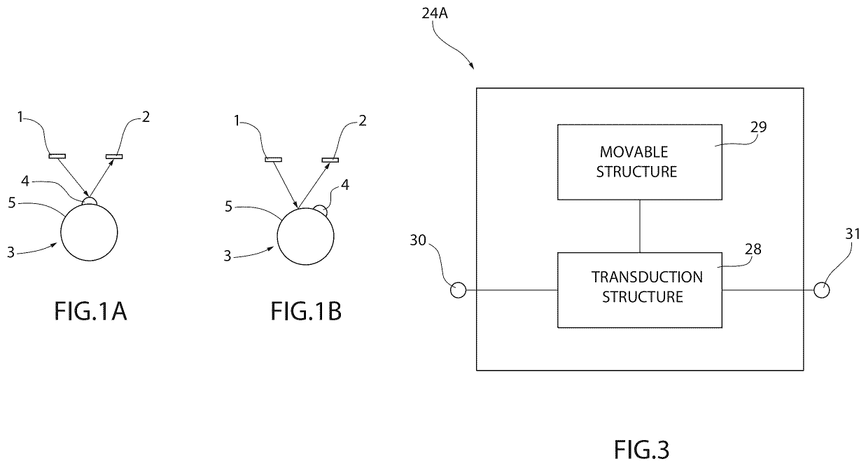

### DETAILED DESCRIPTION

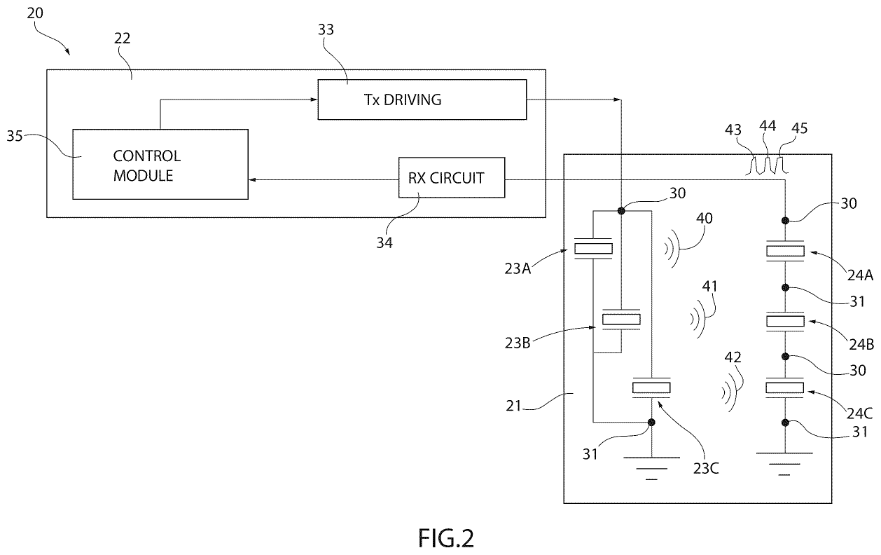

FIG. 2 shows an ultrasound device 20 comprising a transduction device 21 and a control circuit 22 of the transduction device 21.

The transduction device 21 comprises a plurality of transmission transduction modules, in particular the transmission modules 23A, 23B, 23C, and a plurality of reception transduction modules, in particular the reception modules 24A, 24B, 24C.

The transmission modules 23A, 23B, 23C are each configured to emit a respective ultrasound acoustic wave.

The reception modules 24A, 24B, 24C are each configured to detect an impinging ultrasound acoustic wave.

In particular, the transmission modules 23A-23C and the reception modules 24A-24C are configured to emit/detect acoustic waves having a frequency of the order of a few MHz, for example greater than or equal to 1 MHz.

The transmission modules 23A-23C and the reception modules 24A-24C are MEMS ultrasound transducers, that is fabricated by using micro-and nano-machining techniques, for example starting from a wafer of semiconductor material.

FIG. 3 shows a schematic diagram representing the internal structure of any of the transmission modules 23A-23C or reception modules 24A-24C; in particular, purely by way of example, FIG. 3 refers to the reception module 24A. However, what discussed with reference to FIG. 3 may be applied to each of the modules 23A-23C and 24A-24C.

The reception module 24A comprises a transduction structure 28 and a movable structure 29 mutually mechanically coupled to each other.

The movable structure 29 may comprise one or more membranes, cantilevers, or other elements, depending on the specific implementation and application of the device 20.

The movable structure 29 is configured, in reception mode, to move in response to the reception of an impinging acoustic wave.

In particular, the movable structure 29 may undergo a displacement and/or a deformation in response to the reception of the impinging acoustic wave.

The transduction structure 28 is configured to undergo a deformation that depends on the movement of the movable structure 29 and, in response, generate an electrical signal (in particular, a voltage) between two nodes 30, 31 of the reception module 23A.

In practice, the transduction module 24A may be schematically represented as an element having, from an electrical point of view, at least two terminals (nodes 30, 31).

In detail, the movable structure 29 and the transduction structure 28 may be rigidly or elastically coupled to each other.

The transduction structure 28 may be based on a transduction mechanism that is piezoelectric, piezoresistive, capacitive, magnetic, etc., depending on the specific application.

Hereinafter, reference will be made to a transduction structure 28 based on a piezoelectric transduction mechanism, which may allow high sensitivity and low energy consumption to be obtained.

It will be clear to the person skilled in the art that what has been discussed in reference to FIG. 3 for the reception module 24A may also apply to each of the reception modules 24B, 24C and to each of the transmission modules 23A-23C.

In the case of the transmission modules 23A-23C, operating in transmit mode, the transduction structure 28 is configured to undergo deformation and/or displacement as a function of an electrical driving signal (e.g., a voltage) received between the nodes 30, 31. The movable structure 29, mechanically coupled to the transduction structure 28, is configured to move as a function of the deformation and/or movement of the transduction structure 28 and, in response, generate a respective acoustic wave.

The transduction structure 28 may comprise one or more transduction elements and the movable structure 29 may comprise one or more movable elements, depending on the specific implementation.

In particular, each of the reception modules 24A-24C and the transmission modules 23A-23C may be a PMUT device.

For instance, in case each transduction module 23A-23C, 24A-24C is a PMUT device, the transduction structure 28 and the movable structure 29 may comprise an array of transduction elements and movable elements.

With reference once again to FIG. 2, the plurality of reception transduction modules 24A-24C may be mutually arranged in series from an electrical point of view.

In detail, the reception module 24B has the respective node 30 connected to the node 31 of the reception module 24A and the respective node 31 connected to the node 30 of the reception module 24C.

The node 31 of the reception module 24C may be coupled to a reference potential, for example to ground.

The node 30 of the reception module 24A is coupled (e.g., directly connected) to the control circuit 22.

The plurality of transmission transduction modules 23A-23C are arranged mutually in parallel from an electrical point of view.

In detail, the transmission modules 23A-23C have the respective nodes 30 connected to each other and the respective nodes 31 connected to each other.

The node 30 of the transmission modules 23A-23C is coupled (e.g., directly connected) to the control circuit 22. The node 31 of the transmission modules 23A-23C is coupled (e.g., directly connected) to a reference potential node, for example to ground.

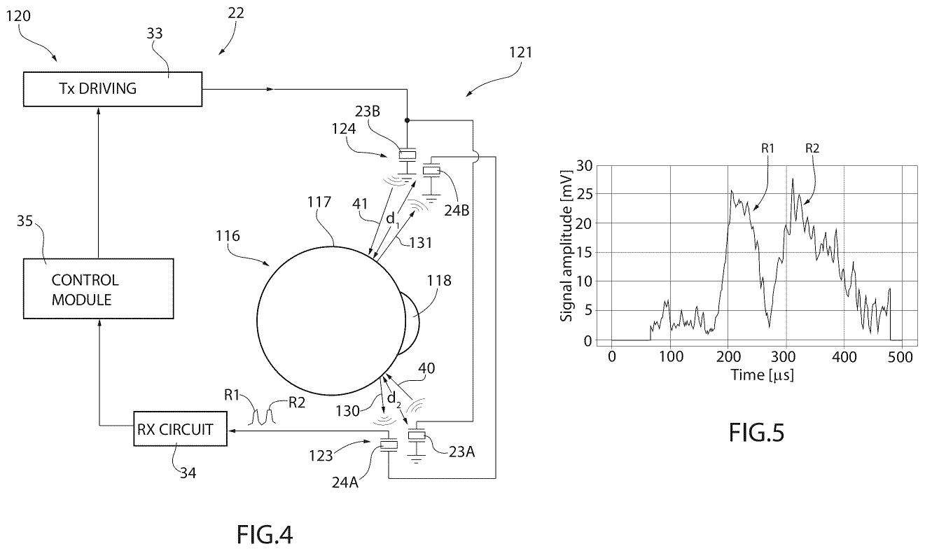

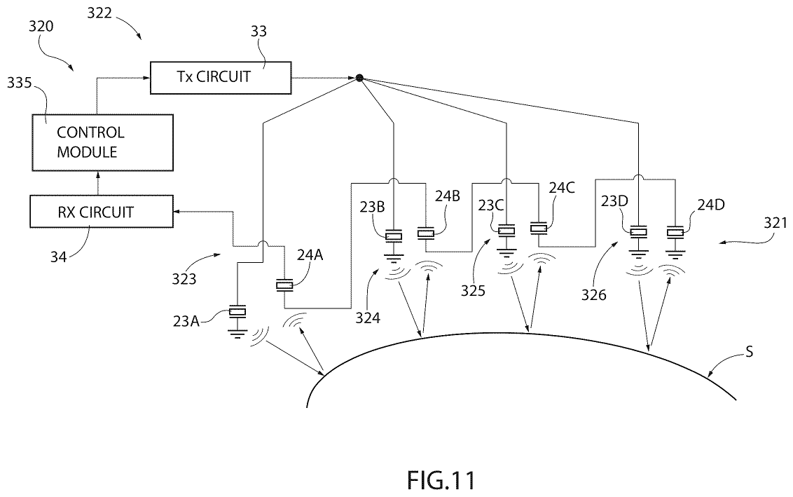

The spatial arrangement of the transmission modules 23A-23C and the reception modules 24A-24C, in particular the relative arrangement between the transmission modules 23A-23C and the reception modules 24A-24C, may vary as a function of the specific application of the ultrasound device 20, as for example described in detail below in reference to FIGS. 4 and 11.

The control circuit 22 comprises a driving circuit 33 coupled to the transmission modules 23A-23C and configured to drive the transmission modules 23A-23C for the emission of an acoustic wave; and a reception circuit 34 coupled to the reception modules 24A-24C and configured to read the electrical signals generated by the reception modules 24A-24C in response to the detection of an acoustic wave.

In detail, the reception circuit 34 is coupled to the node 30 of the reception module 24A. The reception circuit 34 may comprise an amplifier, for example a low noise amplifier (LNA).

In practice, the reception circuit 34 comprises a single reception channel configured to amplify and read the signals generated by all the reception modules 24A-24C.

In the embodiment of FIG. 2, the driving circuit 33 comprises a single transmission channel configured to drive all the transmission modules 23A-23C.

The control circuit 22 further comprises also a control module 35 which is coupled to the driving circuit 33 and the reception circuit 34.

The control module 35 may control the driving circuit 33 and receive amplified electrical signals from the reception circuit 34.

The control module 35 may be configured to determine one or more time-of-flight values between the emission of acoustic waves by the transmission modules 23A-23C and the reception of acoustic waves by the reception modules 24A-24C.

The control module 35 may also be configured to process the measured times of flight and, based on the measured times of flight, determine further quantities or parameters depending on the specific application of the ultrasound device 20.

In detail, the transmission modules 23A-23C and the reception modules 24A-24C may be configured to form a number of TX-RX pairs, hereinafter also referred to as pairs of transducers, wherein each pair of transducers comprises one of the transmission transducers 23A-23C and one of the reception transducers 24A-24C.

In practice, the reception module (e.g., the reception module 24A) of each pair of transducers may be configured to detect the reception of the acoustic wave emitted by the respective transmission module (e.g., the transmission module 23A).

For instance, the transmission module (e.g., 23A) and the reception module (e.g., 24A) of a pair of transducers are configured to have the same operating frequency.

In particular, in the embodiment of FIG. 2, a first pair of transducers comprises the transmission transduction module 23A and the reception transduction module 24A, a second pair of transducers comprises the transmission transduction module 23B and the reception transduction module 24B, and a third pair of transducers comprises the transmission transduction module 23C and the reception transduction module 24C.

The control module 35 may be configured to measure a respective time of flight for each pair.

In detail, the control module 35 may be configured to measure the time of flight of each pair of transducers (23A, 24A; 23B, 24B; and 23C, 24C) using a Time-Division Multiplexing (TDM) or a Frequency-Division Multiplexing (FDM) technique.

The TX-RX pairs may all have the same operating frequency or different operating frequencies, depending on whether the control circuit 22 is configured to perform a TDM or an FDM.

In practice, when in use the ultrasound device 20 may be configured to measure said times of flight with respect to a target body, not shown in FIG. 2, which is arranged in the vicinity of the ultrasound device 20.

In use, the driving circuit 33 provides a driving signal to the transmission modules 23A-23C in such a way that each of them emits a respective acoustic wave 40, 41, and, respectively, 42.

In the embodiment of FIG. 2, wherein the driving circuit 33 forms a single driving channel and the transmission modules 23A-23C are connected in parallel with each other, the transmission modules 23A-23C emit the respective acoustic waves 40, 41, 42 simultaneously with each other.

In this case, the pairs of transducers (23A, 24A; 23B, 24B; and 23C, 24C) may be arranged at different distances one with the other from the target object.

The acoustic waves 40, 41, 42 propagate from the respective transmission module 23A, 23B, 23C towards the target body and are reflected by the target body. The reflected waves then propagate towards the reception modules 24A-24C, which each generate a respective electrical reception signal 43, 44, 45 in response to the reception of the reflected wave associated with the respective transmission module 23A-23C.

Since the reception circuit 34 is coupled to all three reception transduction modules 24A-24C, the reception circuit 34 receives a single signal that is indicative of the electrical signals 43, 44, 45. The single signal received by the reception circuit 34 may therefore be defined as an overall signal indicative of the electrical reception signals 43, 44, 45 generated by the reception transduction modules 24A-24C.

Furthermore, since the pairs of transducers (23A, 24A; 23B, 24B; and 23C, 24C) are arranged at different distances one with the other with respect to the target body, the received signal comprises the electrical reception signals 43, 44, 45 temporally spaced from each other.

The control module 35 may therefore discriminate the electrical reception signals 43, 44, 45 from each other starting from the received signal.

The control module 35 may therefore determine, as a function of the time distance between the emission of the acoustic waves 40-42 by the transmission modules 23A-23C and the reception of the respective reflected components by the reception modules 24A-24C, the respective times of flight.

The fact that the reception modules 24A-24C are coupled to a single reception channel allows to simplify the design of the reception circuit 34, lower its manufacturing costs and lower its energy consumption, even in the presence of a high number of transduction modules.

The ultrasound device 20 may therefore be used efficiently in applications such as eye tracking, gesture recognition, proximity sensor and in general other applications based on measurement of the time of flight.

FIG. 4 shows an ultrasound device 120 configured to detect the movement of an eye 116 having sclera 117 and cornea 118.

The ultrasound device 120 may be incorporated into an apparatus wearable by an individual, such as a pair of glasses, an augmented or virtual reality headset, or other similar apparatus.

The ultrasound device 120 has a structure similar to that discussed for the ultrasound device 20; therefore, elements in common are indicated by the same reference numerals and are not further described in detail. For the detailed description of such elements, therefore, reference is made to what has been described with regard to FIG. 2, unless otherwise specified.

The ultrasound device 120 comprises the control circuit 22 including the driving circuit 33, the reception circuit 34 and the control module 35.

Also in this embodiment, the driving circuit 33 comprises a single transmission channel and the reception circuit 34 comprises a single reception channel.

The ultrasound device 120 further comprises a transduction device 121 comprising a plurality of transmission transduction modules and a plurality of reception transduction modules.

In detail, the transduction device 121 comprises two TX-RX pairs of transducers 123, 124, wherein the pair of transducers 123 comprises the transmission transduction module 23A and the reception transduction module 24A, and the pair of transducers 124 comprises the transmission transduction module 23B and the reception transduction module 24B.

The modules 23A, 24A of the pair of transducers 123 may be formed in a same die or in different dies, depending on the specific application.

The modules 23B, 24B of the pair of transducers 124 may be formed in a same die or in different dies, depending on the specific application.

The transmission modules 23A, 23B are connected in parallel with each other and connected to the driving circuit 33, as discussed in reference to FIG. 2.

The reception modules 24A, 24B are connected in series with each other and connected to the reception circuit 34, as discussed in reference to FIG. 2.

The ultrasound device 120 is configured to detect the orientation of the eye 116 based on a measurement of the time of flight associated with the pair of transducers 123 and a measurement of the time of flight associated with the pair of transducers 124.

The ultrasound device 120 is configured to perform a time division multiplexing (TDM), i.e., in such a way that the electrical signal generated by one of the reception transduction modules (in particular the module 24B in FIG. 4) is temporally delayed with respect to the electrical signal generated by the other of the reception transduction modules (in particular the module 24A in FIG. 4). In this manner, the ultrasound device 120 may measure both the time of flight associated with the pair of transducers 123 and the time of flight associated with the pair of transducers 124 using a single reception channel.

In this regard, in this embodiment, the pairs of transducers 123, 124 are arranged at different distances one with other with respect to the eye 116.

In detail, the pair of transducers 123 is configured to be arranged at a nominal distance d₂ from the eye 116, while the pair of transducers 124 is configured to be arranged at a nominal distance d₁ from the eye 116 that is different from the nominal distance d₂.

In the embodiment of FIG. 4, the distance d₁ is greater than the distance d₂.

In practice, the ultrasound device 120 is configured in such a way that, in at least one rotation condition of the eye 116, the pairs of transducers 123, 124 are arranged with respect to the eye 116 in such a way that the time of flight measurable between the modules 23A, 24A is lower than the time of flight measurable between the modules 23B, 24B.

In the embodiment of FIG. 4, said rotation condition of the eye 116 is the condition wherein the eye 116 is not directed towards the pairs of transducers 123, 124; i.e., a condition wherein the cornea 118 is not directed towards the pairs of transducers 123, 124. In other words, in the condition of use represented in FIG. 4, the acoustic waves emitted by the transmission modules 23A, 23B propagate towards the sclera 117 of the eye 116 and are reflected by the sclera 117 towards the reception modules 24A, 24B.

In detail, the distance d₁ may be defined as a function of the distance between the transmission module 23B and the eye 116 and the distance between the reception module 24B and the eye 116; and the distance d₂ may be defined as a function of the distance between the transmission module 23A and the eye 116 and the distance between the reception module 24A and the eye 116.

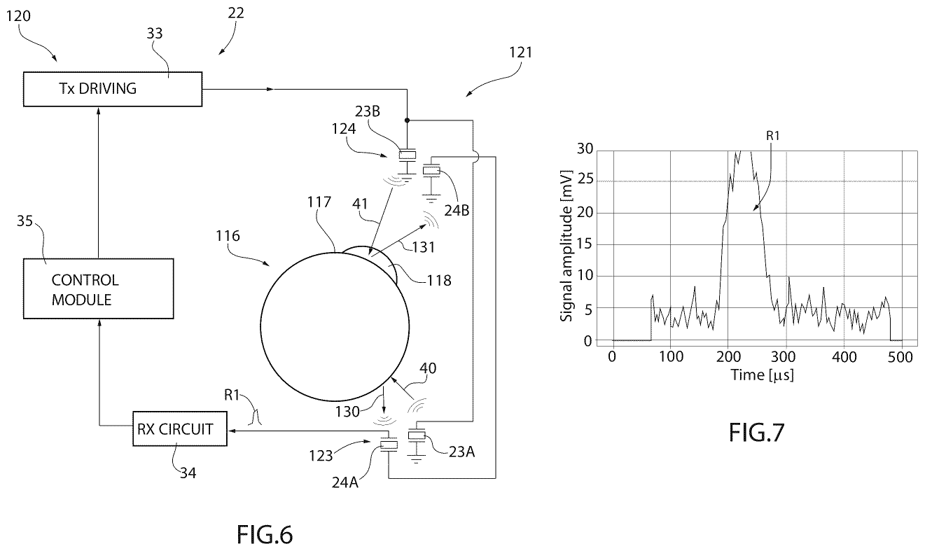

As shown in FIG. 6, the pairs of transducers 123, 124 are arranged with respect to the eye 116 in such a way that, when the eye 116 is directed towards the pair of transducers 124, the acoustic wave 41 emitted by the transduction module 23B propagates towards the cornea 118, but the wave 131 reflected by the cornea 118 does not propagate towards the reception module 24B.

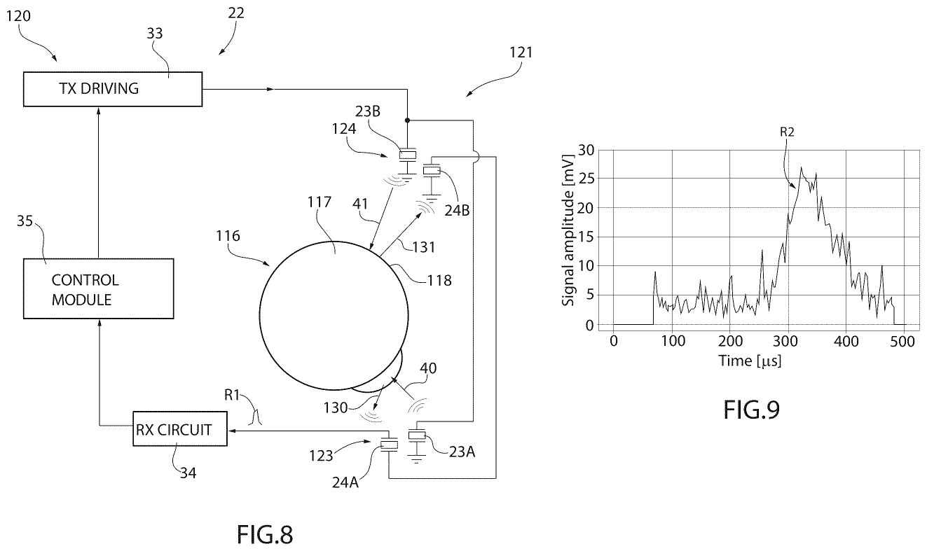

As shown in FIG. 8, the pairs of transducers 123, 124 are arranged with respect to the eye 116 in such a way that, when the eye 116 is directed towards the pair of transducers 123, the acoustic wave 40 emitted by the transduction module 23A propagates towards the cornea 118, but the wave 130 reflected by the cornea 118 does not propagate towards the reception module 24A.

With reference again to FIG. 4, when in use, the driving circuit 33 drives the emission of the acoustic waves 40, 41 by the transmission modules 23A and, respectively, 23B.

In the scenario of FIG. 4, the eye 116 is not directed towards neither the pair of transducers 123 nor the pair of transducers 124.

The acoustic waves 40, 41 therefore both impinge on the sclera 117 of the eye 116 and are then reflected towards the reception module 24A and, respectively, towards the reception module 24B.

In response to the reception of the respective reflected wave 130, the reception module 24A generates a respective electrical signal R1.

In response to the reception of the respective reflected wave 131, the reception module 24B generates a respective electrical signal R2.

The electrical signals R1, R2 are detected by the reception circuit 34.

Since the pair of transducers 124 is arranged at a greater distance from the eye 116 with respect to the pair of transducers 123, the electrical signal R2 generated by the reception module 24B is delayed with respect to the electrical signal R1 generated by the reception module 24A.

The control module 35 is therefore able to distinguish the electrical signal R1 from the electrical signal R2 within the single signal received by the reception circuit 34.

FIG. 5 shows an example of the overall signal received and detected by the reception circuit 34, wherein the peaks associated with the electrical signals R1, R2 are visible.

The peak associated with the signal R1 temporally precedes the peak associated with the signal R2.

The control module 35 may therefore identify the peaks associated with the signals R1, R2, for example through signal processing techniques known per se, and in response, determine the orientation of the eye 116.

In particular, in the example of FIG. 5, the control module 35 determines that the time of flight associated with the peak R1 is about 200 μs and the time of flight associated with the peak R2 is about 300 μs.

In the scenario represented in FIG. 4, the control module 35 determines that the eye 116 is not directed towards either the pair of transducers 123 or towards the pair of transducers 124.

Furthermore, the control module 35 may also be configured to determine a more accurate position of the eye 116 (e.g. the degree of rotation of the eye 116 with respect to the pair of transducers 123 and/or 124), as a function of the time distance between the two peaks R1 and R2, the width of the peaks, the intensity of the peaks, or other similar parameters derivable from the analysis of the signals R1, R2, depending on the specific algorithm implemented.

With reference to FIG. 6, in use, the eye 116 is directed towards the pair of transducers 124.

The acoustic wave 40 then impinges on the sclera 117 of the eye 116 and is reflected towards the reception module 24A.

In response to the reception of the respective reflected wave 130, the reception module 24A generates a respective electrical signal R1.

Conversely, the acoustic wave 41 impinges on the cornea 118 of the eye 116 and therefore the reflected wave 131 is not in line with the reception module 24B.

In the scenario of FIG. 6, the reception module 24B does not detect any reflected wave and therefore does not generate the electrical signal R2 detectable by the reception circuit 34. For example, the reception module 24B may generate an electrical signal, depending on the specific bias or configuration, but such signal is lower than the noise or below a certain threshold.

In this case, therefore, only the electrical signal R1 is detected by the reception circuit 34 within the received signal.

FIG. 7 shows an example of the overall signal received and detected by the reception circuit 34, wherein the peak associated with the electrical signal R1 is visible.

The control module 35 may therefore identify the peak associated with the signal R1.

The control module 35 determines that the time of flight associated with the peak R1, about 200 μs in the example of FIG. 7, refers to the pair of transducers 123.

In response to the detection of the sole peak R1 associated with the pair of transducers 123, the control circuit 35 determines that the eye 116 is directed towards the pair of transducers 124.

With reference to FIG. 8, when in use, the eye 116 is directed towards the pair of transducers 123.

The acoustic wave 41 then impinges on the sclera 117 of the eye 116 and is reflected towards the reception module 24B of the pairs of transducers 124.

In response to the reception of the respective reflected wave 131, the reception module 24B generates a respective electrical signal R2.

Conversely, the acoustic wave 40 impinges on the cornea 118 of the eye 116 and therefore the reflected wave 130 is not in line with the reception module 24A.

In the scenario of FIG. 8, the reception module 24A does not detect any reflected wave and therefore does not generate the electrical signal R1 detectable by the reception circuit 34. For example, the reception module 24A may generate an electrical signal, depending on the specific bias or configuration, but such signal is lower than the noise or below a certain threshold.

In this case therefore, only the electrical signal R2 is detected by the reception circuit 34 within the received signal.

FIG. 9 shows an example of the overall signal received and detected by the reception circuit 34, wherein the peak associated with the electrical signal R2 is visible.

The control module 35 may therefore identify the peak associated with the signal R2.

The control module 35 determines that the time of flight associated with the peak R2, about 300 μs in the example of FIG. 9, refers to the farthest pair of transducers, i.e., the pair of transducers 124.

In response to the detection of the sole peak R2 associated with the pair of transducers 124, the control circuit 35 determines that the eye 116 is directed towards the pair of transducers 123.

The ultrasound device 120 therefore allows tracking the movement of the eye 116 using a plurality of transmission and reception modules.

The fact that the reception modules 24A, 24B are connected to a same reception circuit means that the tracking of the movement of the eye 116 may be performed using a single reception channel, thus simplifying the control circuit 22.

The device 120 may therefore have simple design, low design costs and low energy consumption.

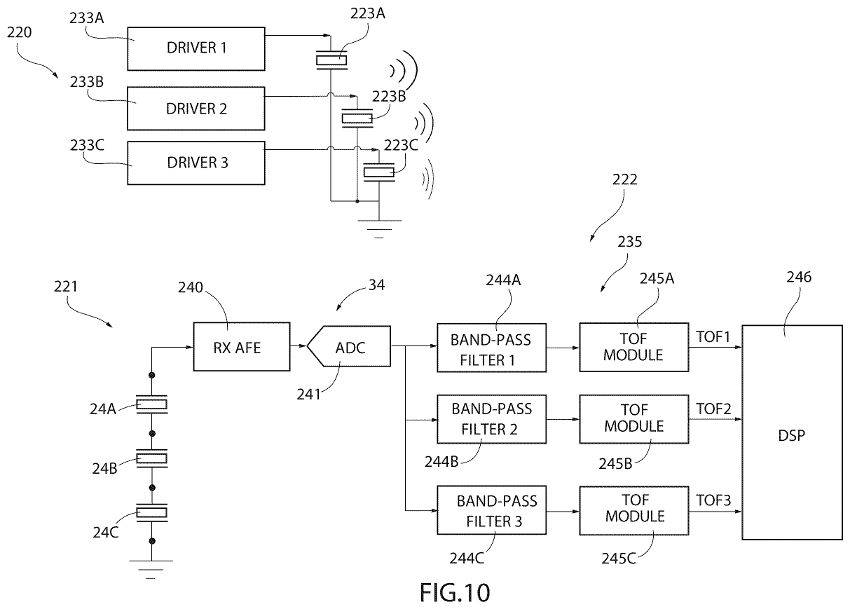

FIG. 10 shows an ultrasound device 220 according to a different embodiment.

The ultrasound device 220 has a general structure similar to that of the devices 20, 120; therefore, elements in common are indicated by the same reference numerals and are not further described in detail. For the detailed description of such elements, therefore, reference is made to what has been described with regard to FIG. 2 or 4, unless otherwise specified.

The ultrasound device 220 comprises a control circuit 222 including a driving circuit, comprising in this embodiment three transmission drivers 233A, 233B, 233C; the reception circuit 34; and a control module 235.

The driving circuit therefore comprises three driving channels.

The reception circuit 34 comprises a reception Analog Front-End 240 which is coupled to the series circuit formed by the reception modules 24A-24C, and an analog-to-digital converter 241.

In practice, also in this embodiment, the reception circuit 34 comprises a single reception channel.

The ultrasound device 220 also comprises a transduction device 221 comprising a plurality of transmission transduction modules 223A-223C and a plurality of reception transduction modules 24A-24C.

The transmission transduction modules 223A-223C and the reception transduction modules 24A-24C may be organized in pairs of transducers TX-RX each comprising a transmission module and a reception module.

The reception modules 24A, 24B are connected in series with each other and connected to the reception circuit 34, as discussed in reference to FIG. 2.

In this embodiment, the transmission modules 233A, 233B, 233C are each driven by a respective driver 233A, 233B, 233C, in such a way that the transmission modules 223A, 223B, 223C may be driven independently one from the other.

In detail, the ultrasound device 220 is configured to perform a frequency division multiplexing (FDM).

In this regard, the pairs of transducers TX-RX are configured to emit and receive acoustic waves within frequency bands different from each other, in particular without mutual overlap between the respective frequency bands.

For instance, the transmission module 223A and the reception module 24A may form a first pair of transducers TX-RX_1; the transmission module 223B and the reception module 24B may form a second pair of transducers TX-RX_2; and the transmission module 223C and the reception module 24C may form a third pair of transducer TX-RX_3, operating within frequency bands separated from each other.

The control module 235 comprises three processing channels each comprising a band-pass filter (filters 244A, 244B and 244C of FIG. 10) and a time-of-flight processing module (TOF modules 245A, 245B, 245C of FIG. 10).

The band-pass filters 244A-244C have passbands different from each other, each corresponding to the frequency band of a respective pair of transducers TX-RX_1, TX-RX_2, TX-RX_3.

The TOF processing modules 245A-245C are each configured to determine the time of flight TOF1, TOF2, TOF3 associated with a respective pair of transducers TX-RX_1, TX-RX_2, TX-RX_3, starting from the filtered signal provided by the respective band-pass filter 244A-244C.

The control module 246 further comprises a processing unit, for example a DSP 246, configured to process the measured times of flight TOF1, TFO2, TOF3 and determine further quantities or parameters, depending on the specific application of the ultrasound device 220.

The frequency multiplexing provided by the ultrasound device 220 allows the ultrasound device 220 to distinguish the signals received by the reception circuit 34, even if the reception circuit 34 has only one reception channel for all the reception modules 24A-24C.

Thus, also the ultrasound device 220 may have low manufacturing costs and low energy consumption, even when the ultrasound device 220 has a high number of reception modules.

It will be clear to the person skilled in the art that the device 220 may be used in a wide range of applications including eye tracking, gesture recognition, proximity sensor, etc.

For instance, similarly to what has been discussed with regard to FIGS. 4, 6 and 8, the device 220 may be used to detect the orientation of the eye 116 and track the movement thereof. In this regard, the frequency multiplexing implemented by the device 220 means that the pairs of transducers TX-RX may be positioned at the same distance from the eye 116.

FIG. 11 shows an ultrasound device 320, according to a further embodiment, comprising a transduction device 321 and a control circuit 322.

The ultrasound device 320 has a general structure similar to that of the ultrasound device 120; therefore, elements in common are indicated by the same reference numerals and are not further described in detail. For the detailed description of such elements, therefore, reference is made to what has been described with regard to FIG. 4, unless otherwise specified.

The transduction device 321 comprises four transmission transduction modules 23A-23D and four reception transduction modules 24A-24D.

In detail, the transduction modules are organized in such a way as to form four TX-RX pairs, hereinafter also referred to as pairs of transducers 323, 324, 325, 326.

The transmission modules 23A-23D are arranged electrically in parallel with each other similarly to what has been described with reference to FIG. 2.

The reception modules 24A-24D are arranged electrically in series with each other similarly to what has been described with reference to FIG. 2.

Furthermore, in this embodiment, the device 320 is configured to determine the topography of a surface S of a target body that is arranged at a distance from the transduction device 321.

In detail, the pairs of transducers 323-326 are arranged at distance from the surface S, along the profile of the surface S.

For each pair of transducers 323-326, the respective transmission modules 23A-23D and reception modules 24A-24D are arranged in such a way that, in use, the acoustic wave emitted by each of the transmission modules 23A-23D impinges on a respective portion of the surface S and is reflected on the respective reception module 24A-24D.

The control circuit 322 comprises the driving circuit 33, configured to drive the transmission modules 23A-23D, and the reception circuit 34, configured to detect the electrical signals generated by the reception modules 24A-24D.

The control circuit 322 further comprises a control module 335 which is configured to determine a time of flight for each of the pairs of transducers 323-326 and, as a function of the times of flight, determine the distance of each pair of transducers 323-326 from the surface S and then, in response, determine the topography of the surface S.

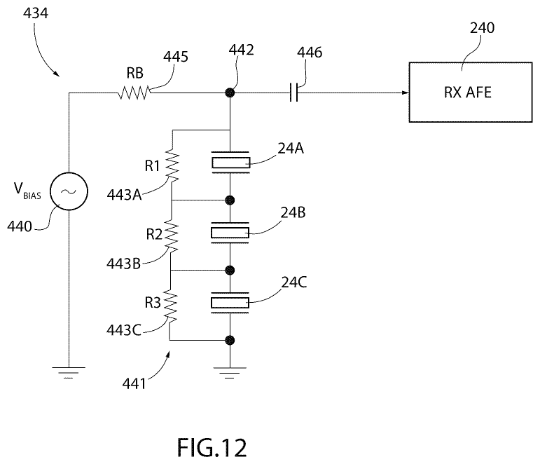

FIG. 12 shows a detailed embodiment of a reception circuit 434 usable in any of the ultrasound devices described above.

For simplicity and clarity of exposition, the reception circuit 434 will be described in reference to the reception modules 24A-24C of the ultrasound device 220.

The reception circuit 434 comprises the reception Analog Front-End 240.

The reception circuit 434 also comprises a bias circuit of the reception modules 24A-24C configured to apply a bias voltage, in particular a DC voltage, to each reception module 24A-24C.

The bias voltage may be applied to the ends 30, 31 of each reception module 24A-24C.

In detail, the reception circuit 434 comprises a bias voltage generator 440 configured to generate a bias voltage V_{BIAS}; and a voltage division network 441.

The reception modules 24A-24C are arranged in such a way as to form a series-type electrical circuit together with the voltage division network 441 between a bias node 442 and a reference potential node (here, to ground).

In detail, the division network 441 comprises a plurality of resistors 443A, 443B, 443C each coupled in parallel to a respective reception module 24A, 24B, 24C.

The resistors 443A, 443B, 443C have resistance R1, R2 and, respectively, R3. The resistances R1, R2, R3 may be equal to each other; this allows the bias voltage V_{BIAS} to be uniformly distributed between the reception modules 24A-24C.

A resistor 445 having resistance RB may be arranged between the voltage generator 440 and the bias node 442, in such a way as to facilitate a DC coupling between the voltage generator 440 and the reception modules 24A-24C. In particular, the resistance RB may be much lower than each of the resistances R1, R2, R3.

A capacitor 446 may be arranged between the bias node 442 and the reception Analog Front-End 240, this allows the reception Analog Front-End 240 to be decoupled from the bias voltage V_{BIAS}; this may be useful when the reception Analog Front-End 240 is configured to operate at a low voltage, lower than the bias voltage V_{BIAS}.

Finally, it is clear that modifications and variations may be made to what has been described and illustrated without thereby departing from the scope of the present invention, as defined in the attached claims.

When the ultrasound device is configured to use time division multiplexing TDM, for example with reference to the ultrasound device 120, the time division of the signals R1, R2 generated by the reception modules 24A, 24B may be achieved by independently driving the two transmission modules 23A, 23B so as to introduce a delay between the emission of the acoustic wave 40 and the acoustic wave 41. For example, this may be achieved by using two driving channels in the driving circuit. In practice, in this manner, it is possible to arrange the pairs of transducers 123, 124 at a same nominal distance from the eye 116 and, at the same time, obtain a time delay in the electrical signals generated by the reception transduction modules 24A, 24B and therefore ensure that the control module 35 may discriminate the signals R1, R2. In fact, in this case, the time distance between the signals R1, R2 is obtained by delaying the emission of the acoustic waves 40, 41 with each other.

For instance, unlike what has been described in reference to FIGS. 2-12, the reception transduction modules 24A-24C may be coupled with each other, from an electrical point of view, in such a way as to form a circuit other than a series circuit, provided that the signal received by the reception circuit 34 or 434 is indicative of the electrical signals generated by the plurality of reception transduction modules. For example, in case the reception circuit is configured to read current signals instead of voltage signals, the reception transduction modules 24A-24C may be coupled with each other, from an electrical point of view, in such a way as to form a parallel-type electrical circuit.

Additionally, or alternatively, when the driving circuit 33 is formed by a single transmission channel, the transmission transduction modules 23A-23C may be coupled to each other from an electrical point of view so as to form an electrical circuit other than a parallel circuit. For example, in case the driving circuit 33 is configured to drive the transmission transduction modules 23A-23C through a current signal, the transmission transduction modules may be coupled to form a series-type electrical circuit.

For instance, the ultrasound device may be configured to determine, starting from the times of flight measured between the emission of the ultrasound acoustic waves and the detection of the ultrasound acoustic waves reflected by a target body, parameters or physical quantities associated with the target body that are different from what has been described above (i.e., different from the position/movement of an individual's eye and the topography of a surface of the target body), depending on the specific application and the specific target body.

For instance, the ultrasound device may comprise a different number of reception and/or transmission modules than shown.

For instance, the control circuit may be formed by circuits, modules, units, etc., implementable through digital, analog, or mixed-signal circuits, depending on the specific application.

For instance, one or more of the driving circuit, reception circuit, and control module may be implemented in whole or in part through dedicated hardware circuits, such as ASICs or FPGAs, and/or through software modules, depending on the specific application.

For instance, transduction device and control circuit may be formed in whole or in part in a same die of semiconductor material, or be distributed in two or more dies, depending on the specific implementation and application.

Finally, the different embodiments described above may be combined to provide further solutions.

1. An ultrasound device, comprising:
a plurality of transmission transduction modules of micro-electro-mechanical systems (MEMS) type, each transmission transduction module configured to emit a respective ultrasound acoustic wave;
a plurality of reception transduction modules of MEMS type, each reception transduction module configured to generate an electrical signal in response to the detection of an impinging ultrasound acoustic wave;
wherein the plurality of reception transduction modules are connected in series with each other; and
control circuitry comprising one or more transmission channels configured to drive the emission of ultrasound acoustic waves by the plurality of transmission transduction modules, and a single reception channel configured to detect the electrical signals generated by the plurality of reception transduction modules, wherein the single reception channel is connected to the plurality of reception transduction modules connected in series with each other.

2. The ultrasound device according to claim 1, wherein the control circuitry is configured to determine, starting from one or more of the detected electrical signals, at least one time of flight between the emission of at least one ultrasound acoustic wave by the plurality of transmission transduction modules and the detection of at least one ultrasound acoustic wave by the plurality of reception transduction modules.

3. The ultrasound device according to claim 2, wherein the control circuitry is configured to implement a frequency division multiplexing so as to determine, starting from one or more of the detected electrical signals, a plurality of times of flight between the ultrasound acoustic waves emitted by the plurality of transmission transduction modules and the ultrasound acoustic waves detected by the plurality of reception transduction modules.

4. The ultrasound device according to claim 2, wherein the control circuitry is configured to implement a time division multiplexing so as to determine, starting from one or more of the detected electrical signals, a plurality of times of flight between the ultrasound acoustic waves emitted by the plurality of transmission transduction modules and the ultrasound acoustic waves detected by the plurality of reception transduction modules.

5. The ultrasound device according to claim 2, wherein the control circuitry is configured to detect the at least one time of flight with respect to a target body, wherein the target body is an eye of an individual, and to determine an orientation or position of the eye as a function of the at least one time of flight.

6. The ultrasound device according to claim 5, including a plurality of pairs of transducers comprising at least a first pair of transducers and a second pair of transducers, wherein the first pair of transducers comprises one of the transmission transduction modules of the plurality of transmission transduction modules and one of the reception transduction modules of the plurality of reception transduction modules, wherein the second pair of transducers comprises another one of the transmission transduction modules of the plurality of transmission transduction modules and another one of the reception transduction modules of the plurality of reception transduction modules;
wherein the control circuitry is configured to determine a first time of flight associated with the first pair of transducers and a second time of flight associated with the second pair of transducers; and
wherein at least one of the first pair of transducers and the second pair of transducers is configured so as that, in use when an eye is directed towards the at least one of the first and the second pairs of transducers, the ultrasound acoustic wave emitted by the respective transmission transduction module propagates towards a cornea of the eye and the corresponding reflected ultrasound acoustic wave does not propagate towards the respective reception transduction module.

7. The ultrasound device according to claim 5, including a plurality of pairs of transducers comprising at least a first pair of transducers and a second pair of transducers, wherein the first pair of transducers comprises one of the transmission transduction modules of the plurality of transmission transduction modules and one of the reception transduction modules of the plurality of reception transduction modules, wherein the second pair of transducers comprises another one of the transmission transduction modules of the plurality of transmission transduction modules and another one of the reception transduction modules of the plurality of reception transduction modules;
wherein the control circuitry is configured to determine a first time of flight associated with the first pair of transducers and a second time of flight associated with the second pair of transducers; and
wherein at least one of the first pair of transducers and the second pair of transducers is configured so as that, in use when an eye is not directed towards the at least one of the first and the second pairs of transducers, the ultrasound acoustic wave emitted by the respective transmission transduction module propagates towards a sclera of the eye and the corresponding reflected ultrasound acoustic wave propagates towards the respective reception transduction module.

8. The ultrasound device according claim 1, including a plurality of pairs of transducers comprising at least a first pair of transducers and a second pair of transducers, wherein the first pair of transducers comprises one of the transmission transduction modules of the plurality of transmission transduction modules and one of the reception transduction modules of the plurality of reception transduction modules, wherein the second pair of transducers comprises another one of the transmission transduction modules of the plurality of transmission transduction modules and another one of the reception transduction modules of the plurality of reception transduction modules;
wherein the control circuitry is configured to determine a first time of flight associated with the first pair of transducers and a second time of flight associated with the second pair of transducers.

9. The ultrasound device according to claim 8, wherein the control circuitry is configured to implement a time division multiplexing so as that the electrical signal generated by the reception transduction module of one of the first pair of transducers and the second pair of transducers is time-delayed with respect to the electrical signal generated by the reception transduction module of the other of the first pair of transducers and the second pair of transducers.

10. The ultrasound device according to claim 9, wherein the first pair of transducers is configured to be arranged at a first nominal distance from a target body with respect to which to measure the first time of flight and wherein the second pair of transducers is configured to be arranged at a second nominal distance from the target body with respect to which to measure the second time of flight, the first distance being different from the second distance.

11. The ultrasound device according to claim 8, wherein the control circuitry is configured to implement a frequency division multiplexing, wherein the first pair of transducers is configured to operate at an operating frequency different from the operating frequency of the second pair of transducers.

12. The ultrasound device according to claim 1, wherein at least one of the plurality of reception transduction modules and the plurality of transmission transduction modules comprise piezoelectric micromachined ultrasonic transducer (PMUT) devices.

13. The ultrasound device according to claim 1, wherein the series connection of the reception transduction modules generates an overall signal indicative of the electrical signals generated by the reception transduction modules for application to the reception channel.

14. The ultrasound device according to claim 1, wherein the control circuitry comprises a transmission channel configured to drive the emission of ultrasound acoustic waves by the plurality of transmission transduction modules.

15. The ultrasound device according to claim 1, wherein the transmission transduction modules are coupled to each other to form a parallel-type electrical circuit.

16. The ultrasound device according to claim 1, wherein the reception channel comprises a bias circuit coupled to the plurality of reception transduction modules and configured to apply a bias voltage to each of the reception transduction modules.

17. A method for controlling an ultrasound device that includes a plurality of transmission transduction modules of micro-electro-mechanical systems (MEMS) type and a plurality of reception transduction modules of MEMS type, the method comprising:
driving, by one or more transmission channels, the emission of ultrasound acoustic waves by the plurality of transmission transduction modules;
connecting the plurality of reception transduction modules in series with each other; and
detecting, by a single reception channel, electrical signals generated by the plurality of reception transduction modules connected in series in response to the detection of impinging ultrasound acoustic waves.

18. The method according to claim 17, further comprising: determining, starting from one or more of the detected electrical signals, at least one time of flight between the emission of at least one ultrasound acoustic wave by the plurality of transmission transduction modules and the detection of at least one ultrasound acoustic wave by the plurality of reception transduction modules.

19. The method according to claim 17, comprising: performing a frequency division multiplexing so as to detect a plurality of times of flight between the ultrasound acoustic waves emitted by the plurality of transmission transduction modules and the ultrasound acoustic waves detected by the plurality of reception transduction modules, as a function of the detected electrical signals.

20. The method according to claim 17, comprising: performing a time division multiplexing so as to detect a plurality of times of flight between the ultrasound acoustic waves emitted by the plurality of transmission transduction modules and the ultrasound acoustic waves detected by the plurality of reception transduction modules, as a function of the detected electrical signals.

21. The method according to claim 17, wherein the ultrasound acoustic waves are emitted in the direction of a target body and the reception transduction modules are configured to detect the ultrasound acoustic waves emitted by the transmission transduction modules and reflected by the target body,
the method further comprising determining at least one parameter associated with the target body, as a function of one or more times of flight detected between emission of the ultrasound acoustic waves and detection of the reflected ultrasound acoustic waves.

22. The method according to claim 21, wherein the target body is an eye and the parameter associated with the target body comprises orientation or position of the eye.
